(19) United States
(12) Patent Application Publication
(10) Pub. No.: US 2003/0012901 A1
(43) Pub. Date: Jan. 16, 2003

(54) Plastic container barrier structure for dry food products

(76) Inventors: Edward Anthony Bezek, Frisco, TX (US); John Joseph Michels, Highland Village, TX (US)

Correspondence Address: CARSTENS YEE & CAHOON, LLP, P O BOX 802334, DALLAS, TX, 75380

(21) Appl. No.: 09/904,666

(22) Filed: Jul. 12, 2001

(51) Int. Cl. B32B 1/02

(52) U.S. Cl. 428/35.4; 428/36.7

(57) ABSTRACT

A multi-layer plastic container having a thin interior layer of EVOH in contact with a dry food product contained therein. The dry food product acts as a desiccant, thereby protecting the EVOH layer from moisture. The use of the dry food product in such fashion eliminates the need for a buried layer configuration or a thick, partially sacrificial, layer of EVOH.

### BACKGROUND OF THE INVENTION

1. Technical Field

The present invention relates to a plastic container barrier structure utilizing a thin film of ethylene-vinyl alcohol (EVOH) in contact with a dry food product, whereby said dry food product acts as a desiccant protecting the EVOH layer from moisture. The invention allows for the use of a thin layer of EVOH as an oxygen barrier in contact with the dry product inside a plastic container.

2. Description of Related Art

In order to enhance the shelf life of a product contained therein, a plastic food container must have adequate barrier properties to protect the product from light and the migration of moisture and oxygen into the container. This is typically accomplished by combining, in a layered arrangement, several polymer films, each film having distinct barrier properties. The typical goal in constructing such container is to provide in the aggregate a layered film container that can be constructed at a minimal cost, and yet provide adequate barrier properties to light, moisture, and oxygen without impacting the taste of the product in the container.

EVOH has been found to be an excellent oxygen barrier that reduces oxygen migration into plastic containers. EVOH has been used successfully in combination with, for example, polyethylene, or polypropylene (PP), where the polypropylene or PP provide the moisture barrier properties for the container. Another benefit of using EVOH in containers for food products is its resistance to the migration of oils and contaminates, either from other film layers migrating into the product or from the product leaching into the container walls. For example, when post-consumer reground (PCR) polyolefin resins are used as one of the film layers for a container, EVOH has been found to be an effective barrier to prohibit contaminates from the PCR resin from being leached into a food product that is placed in the container. An EVOH layer has also been found to be an effective scalping barrier to prevent the absorption of oil and oil-soluble flavors from packaged food.

Unfortunately, EVOH loses its effectivity as an oxygen barrier when it comes in contact with moisture. Consequently, most prior art applications of EVOH film involve the use of EVOH in a “buried” layer configuration, whereby it is sandwiched between two moisture barriers in order to protect the oxygen barrier characteristics of the EVOH. This is illustrated by FIG. 1a, which shows a cross-sectional schematic view of a prior art multi-layered film incorporating EVOH. In the embodiment shown, the outside layer 12 is a PCR resin which is joined by an adhesive layer 14, such as a modified polyethylene, to an EVOH layer 16. The EVOH layer 16 is then joined by another adhesive layer 18 to the interior or product side layer 20 comprising a polyolefin. The interior layer 20 would then be in contact with the product found within the container.

The addition of another moisture barrier layer 20 in the “buried” layer configuration, with no functional purpose other than to protect the EVOH oxygen barrier layer 16, necessarily adds to the cost of the container. Further, placing a layer of film between the EVOH and product may not be advisable because of the “off” flavoring that can sometimes be imparted by polymer films into the product. Consequently, it would be desirable in many food container applications to have the EVOH film layer in direct contact with the product found in the container.

One solution to this problem is detailed in U.S. Pat. No. 5,320,889, which issued on Jun. 14, 1994, and is titled “Plastic Bottle for Food” (the '889 Patent). The '889 Patent teaches a four-layer container structure with an EVOH layer being the most interior, or product side, layer. This is illustrated by FIG. 1b, which is a cross-sectional schematic of the embodiment disclosed by the '889 Patent. In this embodiment, the exterior layer 22 is made up of high density polyethylene which is joined to an intermediate layer 24 of regrind. This intermediate layer 24 is in turn joined by an adhesive layer 28 to the interior layer 16 of EVOH. In order to overcome the problem of the loss of oxygen barrier characteristics as the EVOH layer 16 is exposed to moisture, the '889 Patent teaches that the EVOH layer must be at least a minimum thickness of 0.5 mils, thereby using a portion of the thick EVOH layer as a sacrificial layer to protect the remainder of the EVOH layer.

As explained by the '889 Patent, a dry layer of EVOH which is insulated on both sides from moisture provides a superior oxygen barrier to achieve the best oxygen barrier properties. It is important that the EVOH layer be bone dry and insulated from any moisture coming from inside or outside of the package. In order to achieve this same result without using a buried layer configuration, the '889 Patent discloses that the portion of an EVOH layer which is immediately adjacent to the product (hereinafter the “wet portion”) in the embodiment illustrated in FIG. 1b functions as a moisture barrier to protect the “dry portion” (the portion closer to the adhesive layer 28) of the EVOH layer from moisture within the package, provided the total EVOH layer is thick enough. The wet portion of the EVOH layer, which is in contact with the product, functions as a sacrificial layer insofar as it does not contribute as significantly to the oxygen impermeability. Further, the wet portion of the EVOH layer functions as a moisture barrier, thus preventing moisture from the product from reaching the dry portion of the EVOH layer.

Throughout the '889 Patent, it is continually emphasized that the use of an EVOH layer in contact with the product must be at least 0.5 mils thick in order to accomplish the sacrificial function and protect the dry portion of the EVOH layer sufficiently to maintain its effectiveness as an oxygen barrier. No prior art has overcome the problem of the need to protect the EVOH layer from moisture when it is in contact with the product other than to use a thick (0.5 mils or more) layer of EVOH as disclosed by the '889 Patent.

Consequently, a need exists for a container barrier structure that utilizes a thin layer, meaning less than 0.5 mils, of EVOH as an interior layer in contact with the product while also maintaining the oxygen barrier effectiveness of such EVOH layer. Such invention should minimize use of the EVOH while also maintaining all effective barrier properties for the container as a whole.

### SUMMARY OF THE INVENTION

The proposed invention involves using a thin layer (meaning less than 0.5 mils) of EVOH as an interior layer in a plastic container structure in contact with a dry food product, wherein the dry food product acts as a desiccant. To be effective as a desiccant in this application, the dry food product must have a water activity level of less than 0.6 when sealed in the container. The desiccant properties of such dry food product protect the EVOH layer from moisture that would degrade the oxygen barrier effectiveness of the EVOH layer.

The use of the thin film of EVOH in combination with the dry food product allows for the use of a thin film of EVOH that is not protected by another film layer, and that can be placed directly in contact with the product as an inner-most layer. Consequently, the invention minimizes the use of EVOH and other polymer layers, thereby reducing film costs, while also maintaining effective barrier properties.

The above as well as additional features and advantages of the present invention will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIGS. 1a and 1b are schematic cross-section views of prior art container structures; and

FIG. 2 is a schematic cross-section view of one embodiment of the container structure of the present invention.

### DETAILED DESCRIPTION

FIG. 2 shows a cross-sectional schematic of a four-layer barrier structure of one embodiment of the present invention. Starting with the outside layer, this embodiment shows an exterior moisture barrier layer 32 comprising, for example, high density polyethylene or polypropylene, followed by a regrind layer 34. The interior layer comprises a thin film (less than 0.5 mils) of EVOH which is attached to the regrind layer 32 by way of an adhesive layer 38.

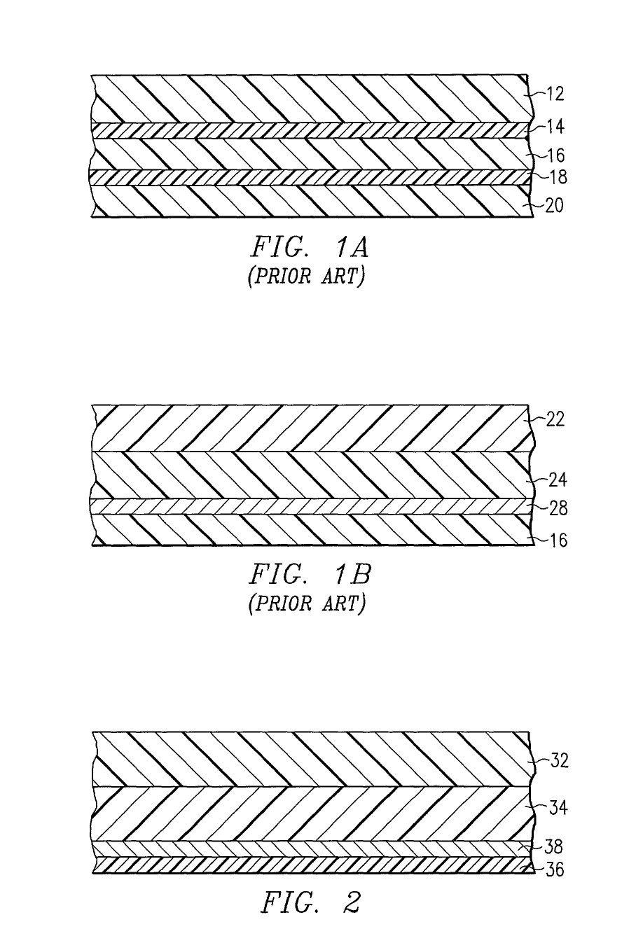

Another embodiment of the present invention could involve only three layers, comprising a moisture barrier, such as high density polyethylene or polypropylene, as the outside layer, EVOH as the inside layer, with an adhesive layer between the moisture barrier layer and the EVOH. The invention can, in fact, be used in five, six, seven, and any other multi-layer configuration as is known in the art, as long as the thin film EVOH layer is the interior layer. Any variety of materials can be used for one or more moisture barrier layers and one or more adhesive layers in any of these configurations. All embodiments of the present invention, however, allow for the use of an EVOH layer that is less than 0.5 mils thick in combination with a dry food product having desiccant properties placed inside the container. With the dry food product acting as a desiccant, moisture, which degrades the oxygen barrier effectiveness of the EVOH, is kept at a minimum inside the container. Consequently, the EVOH is protected from moisture by a moisture barrier on the outside of the container and the desiccant product on the inside of the container. This feature of the invention eliminates the need, and accompanying cost, of a buried layer configuration such as is shown in FIG. 1a, regardless of the thickness of the EVOH layer and enhances the oxygen barrier characteristics of an exposed EVOH layer even when such layer is greater than 0.5 mils thick.

For the purpose of this application, a dry food product having desiccant properties is defined as a food product, typically grain or starch based, with a water activity at packaging of less than 0.6, and preferably less than 0.4. This would include fried, baked, and extruded products made from corn, wheat, and potatoes, such as potato chips, corn chips, and puffed food products, provided they have a water activity of less than 0.6 upon sealing in a container. Such dry food products act as a desiccant that allows the EVOH layer to perform effectively as an oxygen barrier even when the EVOH layer is less than 0.1 mils in thickness, and improve the EVOH oxygen barrier properties at any thickness. It should be understood that the same concept, that is using a dry food product acting as a desiccant, can also improve the moisture barrier properties of other moisture barrier films such as nylon.

The ability to construct a container with a 0.1 mils thick EVOH layer as the only oxygen barrier layer and without the need for a buried layer arrangement provides for an inexpensive and simple container design. Consequently, the instant invention is a substantial improvement over the prior art.

While the invention has been particularly shown and described with reference to a preferred embodiment, it will be understood by those skilled in the art that various changes in form and detail may be made therein without departing from the spirit and scope of the invention.

What is claimed is:

1. A method for making a plastic dry food container, said method comprising the steps of:
a) forming a thin sheet of EVOH film as an interior surface of the container;
b) placing a dry food product within said container; and
c) sealing said container.

2. The method of claim 1 wherein the EVOH layer is less than 0.5 mils thick.

3. The method of claim 1 wherein the EVOH layer is approximately 0.1 mils thick.

4. The method of claim 1 wherein the dry food product acts as a desiccant to draw moisture away from the EVOH layer.

5. The method of claim 4 wherein the dry food product comprises a water activity of less than 0.6 upon the sealing of step c.

6. The method of claim 4 wherein the dry food product comprises a water activity of less than 0.4 upon the sealing of step c.

7. A multi-layer plastic container comprising:
an interior layer of EVOH, said layer of EVOH being less than 0.5 mils thick;
a dry food product having desiccant properties sealed within said container.

8. The multi-layer plastic container of claim 7 wherein said dry food product comprises a water activity of less than 0.6.

9. The multi-layer plastic container of claim 7 wherein said dry food product comprises a water activity of less than 0.4.

10. The multi-layer plastic container of claim 7 wherein said layer of EVOH is approximately 0.1 mils thick.
